(19) United States
(12) Patent Application Publication
(10) Pub. No.: US 2025/0118278 A1
(43) Pub. Date: Apr. 10, 2025

(54) METHOD AND SYSTEM FOR ANALYZING MUSIC RHYTHM IN REAL TIME

(71) Applicant: REALTEK SEMICONDUCTOR CORP., HSINCHU (TW)

(72) Inventor: YING-YING CHAO, HSINCHU (TW)

(21) Appl. No.: 18/906,394

(22) Filed: Oct. 4, 2024

(30) Foreign Application Priority Data
Oct. 5, 2023 (TW) 112138193

(51) Int. Cl. G10H 1/00

(52) U.S. Cl. CPC G10H 1/0008; G10H 2210/071; G10H 2210/076

(57) ABSTRACT

A method and a system for analyzing music rhythm in real time are provided. In the method, a device receives audio via an input interface. The audio is decoded by an audio-processing circuit to extract frame information. A hop size is obtained according to a frame size and an overlapped frame size set, and a frame rate is calculated according to the sampling rate and the hop size. An initial value of a beat period can be calculated according to the sampling rate and an initial BPM value. A beat location can be obtained based on a quantity of sampling points in a beat. The system uses a recursive algorithm to speculate a next beat location. A new beat period is recalculated according to the frame information of the audio in a past period of time. The next beat location is obtained and added with a beat-prompting note.

### CROSS-REFERENCE TO RELATED PATENT APPLICATION

This application claims the benefit of priority to Taiwan Patent Application No. 112138193, filed on Oct. 5, 2023. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a technology of adding a beat-prompting note into music, and more particularly to a method and a system for analyzing music rhythm in real time for determining if the beat-prompting note can be added to the music with a stable rhythm.

### BACKGROUND OF THE DISCLOSURE

When a person is listening to music or watching a music video, he/she may want to sing along with the music. However, for an inexperienced person or a young person, catching the beats of the music is not easy. Hence, it is conventional to add beat-prompting notes to the music, so that the person can sing with the music more easily.

Conventionally, a player is capable of providing the beat-prompting notes when playing the music. However, an algorithm for speculating a rhythm is generally an offline model, and the offline model needs to analyze an entire piece of the music before obtaining the rhythm. Therefore, the beat-prompting notes need to be prepared before the music is played. In the conventional technology, it is impossible to obtain real-time beat information when the music is being played on demand.

### SUMMARY OF THE DISCLOSURE

In response to the above-referenced technical inadequacy, the present disclosure provides a method and a system for analyzing music rhythm in real time, so as to be capable of providing rhythm information when playing music on demand. The system is operated in a device through a circuitry or a software method. In addition to providing an audio-processing circuit in the device, the device includes an audio analysis module connected with the audio-processing circuit. The audio-processing circuit is used to perform real-time music rhythm analysis.

In the method, the system receives an audio via an input interface, and uses the audio-processing circuit to decode the audio for retrieving frame information of the audio. The frame information includes a sampling rate. Next, a hop size can be obtained according to a frame size and an overlapped frame size. A frame rate can be calculated according to the sampling rate and the hop size. An initial value of a beat period is calculated according to the sampling rate and an initial BPM (beats per minute) value, so as to obtain a beat location according to a quantity of sampling points in one beat.

Afterwards, a next beat location can be speculated by a recursive algorithm. The frame rate is referred to for calculating a quantity of audio frames in a past period of time, and a new beat period is calculated according to beats per minute, so as to speculate the next beat location according to the new beat period.

Thus, the system can be configured to re-calculate the new beat period at intervals based on data of the audio frames in the past period of time, so as to re-speculate the next beat location.

Preferably, when the audio is a pulse-code modulated multi-channel audio, an averaging operation is performed on digital signals of multiple audio frames at a same time for forming a mono-channel audio that is provided for real-time music rhythm analysis.

Preferably, the frame rate indicates a quantity of proxy audio frames in one second, and the proxy audio frame is obtained based on the frame size of an original audio frame and the overlapped frame size set by the system.

In an aspect of the present disclosure, in the process of calculating the new beat period, an auto-correlation function is used for finding out a repeating pattern based on a correlation of the frame information of the audio at different time points, and the new beat period can be re-calculated based on a period having a maximum of the auto-correlation function.

Further, the auto-correlation function introduces an onset value, and the onset value of each one of the proxy audio frames in a time period is calculated. After that, a maximum of the onset values or values calculated from the onset values in the time period is determined for speculating the new beat period.

Further, a beat detection value is incorporated. A maximum beat characteristic value of the sampling points around the onset values of the proxy audio frames in the time period is calculated. The maximum beat characteristic value can be regarded as the beat detection value of the proxy audio frame. Beat detection values in a next beat period can be speculated according to all of the beat detection values in a past beat period. A maximum of the beat detection values in the next beat period can be regarded as a beat location of the next beat period.

Further, after the next beat location of the new beat period is obtained, multiple time differences of multiple adjacent beat locations are calculated by retracing multiple beat locations, and the system is able to determine whether or not the audio has a stable rhythm. When the system determines that the audio has the stable rhythm, a beat-prompting note can be added at each beat location. After that, when the audio-processing circuit outputs the processed audio via an output interface, the audio is synthesized with the beat-prompting note that is added at each beat location.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic diagram illustrating a framework of a system that operates a method for analyzing music rhythm in real time according to one embodiment of the present disclosure;

FIG. 2 is a flowchart illustrating the method for analyzing music rhythm in real time according to one embodiment of the present disclosure;

FIG. 3 is a flowchart illustrating a pre-processing procedure in the method for analyzing music rhythm in real time according to one embodiment of the present disclosure;

FIG. 4 is a flowchart illustrating another pre-processing procedure in the method for analyzing music rhythm in real time according to one embodiment of the present disclosure;

FIG. 5 is a schematic diagram depicting a hop size and a frame rate that are obtained in another pre-processing procedure according to one embodiment of the present disclosure;

FIG. 6 is a flowchart illustrating a subsequent process of detecting beats in the method for analyzing music rhythm in real time according to one embodiment of the present disclosure;

FIG. 7 is a flowchart illustrating a process of detecting a next beat location according a speculated beat period according to one embodiment of the present disclosure;

FIG. 8 is a schematic diagram depicting an onset value being determined through an auto-correlation function according to one embodiment of the present disclosure;

FIG. 9 is a schematic diagram illustrating a beat location being described by a beat detection value according to one embodiment of the present disclosure;

FIG. 10 is a schematic diagram illustrating the next beat location being speculated through description of the beat detection value according to one embodiment of the present disclosure; and

FIG. 11 is a schematic diagram illustrating frame information of an audio that is used to determine whether or not an audio rhythm is stable according to one embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

The present disclosure relates to a method for analyzing music rhythm in real time and a system for analyzing music rhythm in real time. The system is applied to a device. When the device receives audiovisual data, a video and an audio can be decoded, decompressed, and processed respectively by software and hardware that are used to process the video and the audio. Afterwards, the video and the audio can be appropriately encoded as playable images and sounds. In particular, when a content inputted to the device is an audiovisual content (e.g., a music video, MV) relating to music or only the audio (without images), the music can be added with one or more beat-prompting notes through the method and the system provided by the present disclosure. The beat-prompting notes can be beeps or other sounds that are configured to be added at one or more locations of accents within every bar of the music, at locations of both accent and secondary accent within every bar of the music, or at every beat within every bar of the music. In this way, a user can easily follow the beat-prompting notes to sing a song.

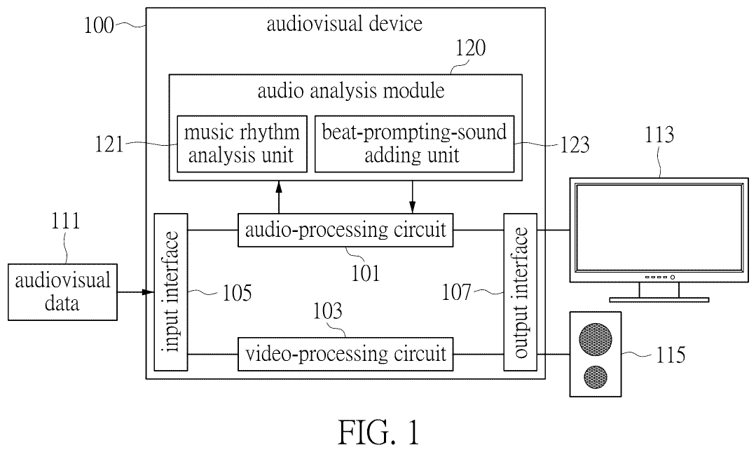

According to one of the embodiments of the present disclosure, FIG. 1 is a schematic diagram illustrating a framework of the system performing the method for analyzing music rhythm in real time. The system is installed in a specific device. The system can be a circuit system implemented by hardware in the device, or a software system that is implemented by computer programs in the device.

The method for analyzing music rhythm in real time is operated in the device that is, for example, a set-top box (STB), a smart TV, or a computer device. In FIG. 1, a device 100 is introduced. The device 100 can be an internal device or an external device of a television system. The device 100 includes an audiovisual processing circuit that is implemented through collaboration of software and hardware.

According to the embodiment shown in the diagram of the present disclosure, main circuit components of the device 100 include an input/output interface (which includes an input interface 105 and an output interface 107) and a data-processing circuit. As known to those skilled in the related art, the audio and the video can be respectively processed by an audio-processing circuit 101 and a video-processing circuit 103 and outputted to the device 100 that connects with a display 113 and a speaker 115. In one embodiment of the system of the present disclosure, input/output ends of the audio-processing circuit 101 connect with an audio analysis module 120 that uses circuits, firmware, or software to implement a music rhythm analysis unit 121 and a beat-prompting-sound adding unit 123. The music rhythm analysis unit 121 is mainly used to analyze beat periods of the audio, so as to acquire beat locations. The beat-prompting-sound adding unit 123 relies on the beat locations that are obtained through a real-time analysis to add beat-prompting notes in the audio.

The audio analysis module 120 performs the method for analyzing music rhythm in real time. In the method, the audio analysis module 120 receives audiovisual data 111 including audio and video via the input interface 105 of the device 100. The video is processed by the video-processing circuit 103 (details thereof will not be reiterated herein), and the processed video is outputted to the display 113 for displaying the video via the output interface 107. The audio is processed by the audio-processing circuit 101, and sounds decoded from the audio are outputted to the speaker 115 for playing the sounds via the output interface 107. In particular, the music rhythm analysis unit 121 of the audio analysis module 120 obtains the beat locations from the audio. Afterwards, the beat-prompting-sound adding unit 123 can synthesize the beat-prompting notes and the audio in the beat locations, and then the audio-processing circuit 101 outputs the audio in a specific encoding format.

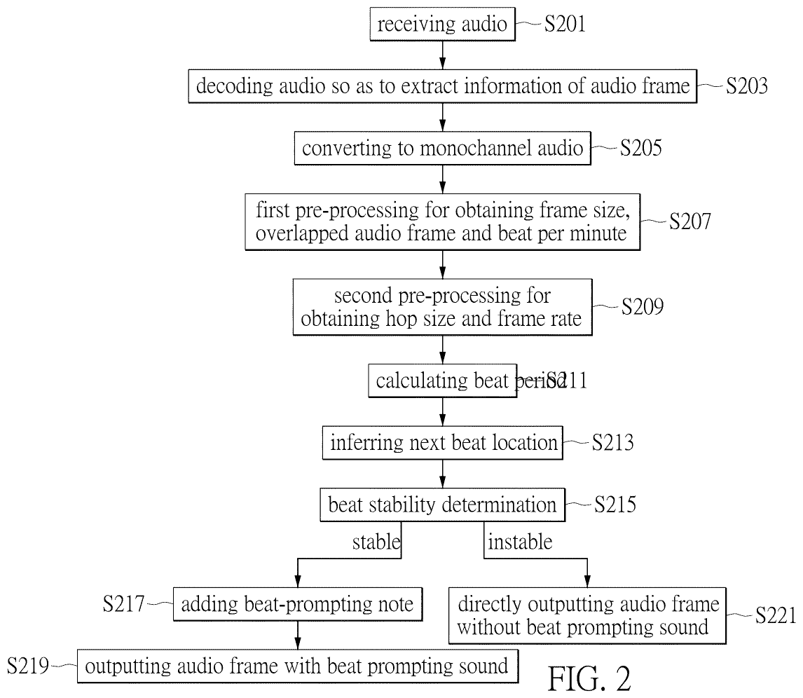

The system operated in the device 100 can be an embedded system that is used to perform the method for analyzing music rhythm in real time. Reference can be made to FIG. 2, which is a flowchart illustrating the method for analyzing music rhythm in real time according to the present disclosure.

In the flowchart, in the beginning, the system operated in the device receives an audio via an input interface of the device (step S201). The audio-processing circuit is used to decode the audio, so as to extract frame information of the audio. The frame information of the audio is, for example, a sampling rate indicating a quantity of sampling points over one second (step S203). The sampling rate is audio-related information, and the sampling rate varies with different audios.

Next, according to one embodiment of the present disclosure, when the audio is a multi-channel audio, a software method can be applied to the audio. For example, an averaging operation is performed on digital signals of multiple audio frames at the same time for forming a mono-channel audio that is provided for real-time music rhythm analysis (step S205).

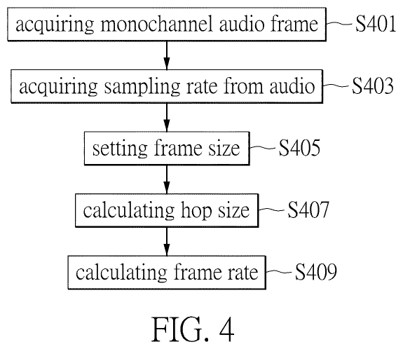

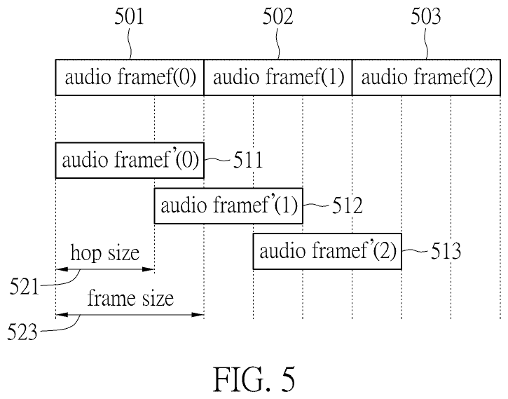

Next, a pre-processing procedure is performed on the audio. For example, step S207 is the first step of the pre-processing procedure that includes system settings such as a frame size, an overlapped frame size, and beats per minute (BPM). Thus, in step S209 (which is the second step of the pre-processing procedure), a hop size can be obtained according to the frame size and the overlapped frame size. A frame rate (frames per second) can be calculated according to the sampling rate and the hop size. It should be noted that, referring to FIG. 5, a proxy audio frame can be obtained based on the frame size of an original audio frame and the overlapped frame size set by the system. The frame rate indicates a quantity of the proxy audio frames in one second, and the frame rate can be calculated through the flowchart shown in FIG. 4.

It should be noted that, in the technical field of digital audio, adjacent audio frames of the audio in a specific encoding format may be overlapped when sampling. This is caused by a slight change occurring in the adjacent audio frames if the audio signals are relatively unstable. In order to suppress the slight change, the system allows the adjacent audio frames to have an overlapped region. For example, an overlapped frame occupies about a half or one third of the original audio frame in size. Since the overlapped audio frame can effectively conceal an error in the audio, a hop size needs to be calculated according to a frame size and an overlapped frame size set by the system when the audio is decoded. The hop size is referred to for calculating the subsequent beat periods. The hop size indicates distance points (e.g., the sampling points) between a starting point of an audio frame and a next starting point of a next audio frame. The hop size is equal to subtracting the overlapped frame size (e.g., a quantity of sampling points within an overlapped audio) from the frame size (e.g., a quantity of sampling points within an audio frame). The frame rate indicates a quantity of the audio frames per one second. The beat period indicates a quantity of the audio frames between two beats. The beat period is used to speculate a next beat.

In particular, according to one embodiment of the present disclosure, after step S211, a recursive algorithm is adopted in the method for speculating a next beat location. The frame rate can be referred to for calculating a quantity of audio frames in a past period of time, and a new beat period can be calculated according to beats per minute. The new beat period can be used to speculate the next beat location (step S213). When the recursive algorithm is performed, the system can re-calculate the new beat period according to the quantity of audio frames for the past period of time at intervals, so as to re-speculate the next beat location.

The system re-calculates the new beat period at intervals and speculates the next beat location, and accordingly the system can determine whether or not the rhythm of the audio is stable. For example, in step S215 of FIG. 2, the system determines beat stability, namely determines whether or not the audio has a stable rhythm by retracing multiple beat locations for calculating multiple time differences among the adjacent beat locations.

Reference is made to FIG. 2. If it is determined that the rhythm is stable in step S215, a software method is incorporated to add the beat-prompting notes at the beat locations that are determined by the above steps (step S217). Through the output interface, the audio-processing circuit outputs the audio that is to be synthesized with the beat-prompting note added at each of the beat locations. Therefore, the audio having the audio frames with the beat-prompting notes can be outputted (step S219).

In one embodiment of adding the beat-prompting notes, after the next beat location is determined and the audio is determined to have a stable rhythm, the audio can automatically add beeps as the beat-prompting notes. Therefore, when the user randomly chooses one of the streaming videos, a function of enabling the beat-prompting notes is controlled to be activated in the device. The beat-prompting notes act as assistance for body rhythm or assistance for performance practice. After the function of enabling the beat-prompting notes is activated, the beat-prompting notes with a normal speed (e.g., adding the beat-prompting notes based on beats per minute (BPM)), the allegro beat-prompting notes (e.g., adding the beat-prompting note with double BPM), or the adagio beat-prompting notes (e.g., adding the beat-prompting notes with half BPM) are used as beats for an auxiliary sound effect.

Conversely, if it is determined that the rhythm of the audio is unstable in step S215 of FIG. 2, none of the beat-prompting notes is added, and the audio consisting of the audio frames (without the beat-prompting notes) can be directly outputted (step S221).

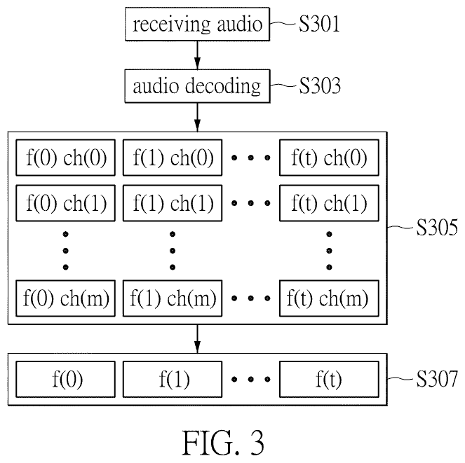

One of the embodiments of the above-described pre-processing procedure in step S207 of FIG. 2 can refer to the flowchart shown in FIG. 3. In FIG. 3, when the system receives an audio by a device (step S301), the audio is decoded (step S303). If the audio is a pulse-code-modulation (PCM) multi-channel audio, the audio is decoded to generate multi-channel audio frames f(t) (step S305).

The diagram shows that the output of an audio decoder is in units of audio frames on a time axis. Each time point on the time axis includes audio frames with one or more channels. Each of the audio frames is a digital audio in a form of pulse-code-modulation (PCM). The digital audio can be expressed by the audio frames having f(0)ch(0), f(1)ch(0), . . . f(t)ch(0) in a channel 0 (ch(0)); f(0)ch(1), f(1)ch(1), . . . f(t)ch(1) in a channel 1 (ch(1)); and f(0)ch(m), f(1)ch(m), . . . f(t)ch(m) in a channel m (ch(m)).

Next, the multi-channel audio is converted to a mono-channel. In an aspect of the present disclosure, an averaging operation is performed on the digital signals of the audio frames at the same time, so as to form the mono-channel audio (f(0), f(1), . . . f(t)) used for real-time music rhythm analysis (step S307).

The second step of the pre-processing procedure described in step S209 of FIG. 2 can refer to the flowchart shown in FIG. 4. A basic formula for processing the audio is such as steps (a) to (g) depicted in Equation 1. The values shown in the formula are merely provided for illustration purposes, but are not to be construed as limiting the scope of the present disclosure.

The flowchart shown in the diagram can refer to Equation 1. The system firstly extracts mono-channel audio frames from an audio (step S401). If the sampling rate of the audio is 44,100, the audio is composed of 44,100 sampling points per second (step S403).

The system settings include a frame size that indicates a quantity of sampling points in one audio frame. For example, the frame size is 1,024, which means that an original audio frame includes 1024 sampling points (step S405). The system settings also include an overlapped frame size that indicates an overlapped audio frame between two adjacent audio frames. For example, the overlapped audio frame includes 512 sampling points.

Thus, a hop size can be obtained according to the frame size (e.g., 1024) and the overlapped frame size (e.g., 512). That is, the hop size is equal to subtracting the overlapped frame size from the frame size. The present example shows that the hop size is 512 sampling points, which is equal to subtracting the overlapped frame size (i.e., 512) from the frame size (i.e., 1024) (step S407).

Next, the frame rate can be obtained by dividing the sampling rate by the hop size. An exemplary example in Equation 1 shows that the frame rate is 86.13, which is equal to 44100 divided by 512. This means that the audio frame has 86.13 sampling points (i.e., the frame rate=the sampling rate/the hop size) (step S409).

FIG. 5 is a schematic diagram illustrating the hop size and the frame rate that are obtained in the second step of the pre-processing procedure (step S209 of FIG. 2) according to one embodiment of the present disclosure. As described above, in an audio under a specific encoding format, the adjacent audio frames may be overlapped while sampling, and the overlapped audio frame can effectively conceal errors in the audio. Therefore, when the audio is decoded, the hop size should be firstly calculated according to the frame size and the overlapped frame size set by the system, so as to calculate subsequent beat periods.

According to the schematic diagram shown in FIG. 5, a first audio frame (f(0)) 501, a second audio frame (f(1)) 502, and a third audio frame (f(2)) 503 are successively received, and each of the audio frames has a frame size 523. There is an overlapped portion between adjacent audio frames. Before the beat period is calculated, the hop size should be obtained firstly. As shown in the schematic diagram, after the overlapped portion between the adjacent audio frames is removed, a first proxy audio frame (f′(0)) 511, a second proxy audio frame (f(1)) 512, and a third proxy audio frame (f′(2)) 513 are obtained. Therefore, the hop size 521 can be obtained based on the frame size 523 and the overlapped frame size. The proxy audio frame (f′(t)) is obtained by overlapping the adjacent audio frames (f(t)). The proxy audio frame (f′(t)) is used to detect the beats.

The present example shows that the hop size 521 is a quantity of sampling points in a distance between a starting point of the first audio frame 501 and a starting point of the second audio frame 502. The hop size 521 equals to subtracting an overlapped frame size (i.e., a quantity of sampling points covered by an overlapped audio frame) from a frame size (i.e., a quantity of sampling points covered by an audio frame). Therefore, the proxy audio frame is obtained based on the frame size of an original audio frame and the overlapped frame size set by the system. The frame rate that can be calculated according to the sampling rate and the hop size indicates a quantity of the proxy audio frames (f′(t)) in one second.

After the above-mentioned pre-processing procedure is completed, a beat period can be calculated according to the sampling rate obtained by the above steps and an initial value of beats per minute (i.e., an initial BPM value). The beat period is an initial value of the quantity of samples in a beat τ. The quantity of samples in a beat can be referred to for obtaining the beat locations (step S211). As shown in step (f) of Equation 1, when the beats per minute are given to be 120, the beat period calculated in step (g) is 43.06 audio frames.

That is, a beat location is present for every 43.06 audio frames.

Equation 1 is expressed by steps of:
(a) giving a sampling rate of 44100 sampling points per second;
(b) the system setting a frame size to be equal to 1024 samples;
(c) the system setting an overlapped frame size to be equal to 512 samples;
(d) obtaining the hop size that includes 512 samples by subtracting the overlapped frame size from the frame size;
(e) frame rate=sample rate/hop size=44100/512=86.13 (frame per second);
(f) setting beats per minute (BPM) to be 120; and
(g) calculating a beat period=(60*(sample rate/BPM))/hop size=60*(44100)/120)/512=43.06 (frame).

According to the flowchart illustrating the method for analyzing music rhythm in real time in FIG. 2, after the pre-processing procedures illustrated in FIG. 3 and FIG. 4, an initial value of the beat period (i) can be calculated according to the sampling rate obtained from the audio and the initial BPM (beats per minute) value set by the system or retrieved from the audio. Then, a quantity (b) of the sampling points included in one beat can be calculated. Accordingly, a beat appears in every “b” sampling points, and a next beat location of a next beat can also be speculated.

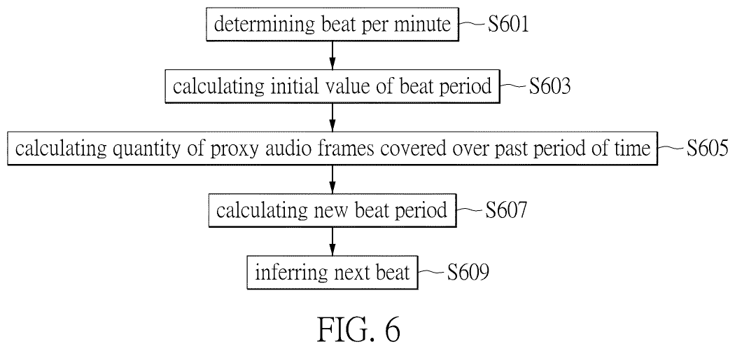

Generally, the initial beat period can be referred to for speculating the next beat location of the next beat. The beat-prompting notes can be added in the music when it has a stable music rhythm. However, for various types of music, there is no guarantee that the rhythm of the music is always the same. As such, in the method for analyzing music rhythm in real time, the beat location is continuously detected for determining whether or not the beat-prompting notes can be stably outputted when the music is being played. Reference is made to FIG. 6, which is a flowchart illustrating a process of detecting the subsequent beats.

The flowchart shown in the diagram adopts a dynamic programming method. In the method for analyzing music rhythm in real time, a recursive algorithm is used to speculate the beat locations. According to one embodiment of the present disclosure, an initial BPM (beats per minute) value is firstly decided (step S601). In addition to deciding the initial BPM value according to the system settings, the initial BPM value can also be obtained from an original audio when starting to play the music. Next, the initial value of the beat period (i) can be calculated according to the sampling rate obtained from the audio and the hop size set by the system (step S603). In this regard, reference can be made to Equation 1.

For example, a common initial BPM value is between 60 and 160, the sampling points obtained in the beat period (r) are generally between 44100 and 16537.5, and the quantity of the audio frames in accordance with the frame rate is between 86.13 and 32.

After that, the beat locations can be detected at intervals (e.g., “u” seconds) that are preset by the system. Therefore, the beat period (τ) can be speculated based on the data for a past period of time (e.g., “u” seconds). According to one embodiment of the present disclosure, in the step for re-speculating the beat period, the frame rate (i.e., a quantity of audio frames per second) can also be calculated according to a sampling rate and a hop size. Next, a quantity of the proxy audio frames (f′(t)) for the past period of time (e.g., “u” seconds) can be calculated (step S605). The quantity of the proxy audio frames can be calculated by Equation 2.

$$data in “ u ” seconds denotes u * frame rate = u * ( sample rate / hop size ) = u * ( 44100 / 512 ) = u * 86.13 f ’ ( t ) . \qquad Equation 2$$

When the system obtains the quantity of the proxy audio frames for a period of time, the system re-speculates a new beat period according to beats per minute (BPM) (step S607), and then speculates the next beat location (step S609).

When “u” is exemplified to be six seconds, the quantity of the proxy audio frames included in “u” seconds is represented by the proxy audio frame (f′(t)) that is “6*(44100/512)=516.79.” BPM of music is generally between 60 and 160. By Equation 2, the beat period (τ) falls between 86.13 proxy audio frames and 32 proxy audio frames. This means that the quantity of beats in 6 seconds is between 6 (e.g., 516.79/86.13 is about 6) beats and 16 (e.g., 516.79/32 is about 16) beats. The above-mentioned data can be referred to for determining whether or not the music has a stable rhythm, and for speculating the next beat.

According to an embodiment of the speculated new beat period (step S607), the system will consume a great amount of computing power to constantly calculate the new beat period when continuously receiving audios. However, the computing power can be reduced. According to one of the embodiments, in the method for analyzing music rhythm in real time, instead of calculating every proxy audio frame, the beat period can be re-speculated only if a specific proxy audio frame is speculated as one of the beat locations.

In one further embodiment of the present disclosure, in order to reduce the amount of computation, when the quantity of the proxy audio frames included in a past period of time (e.g., “u” seconds) is calculated, an auto-correlation function (ACF) is incorporated for acquiring a repeating pattern based on correlations of frame information of the audio at different time points, and the beat period is re-speculated by referring to a period having a maximum of the auto-correlation function.

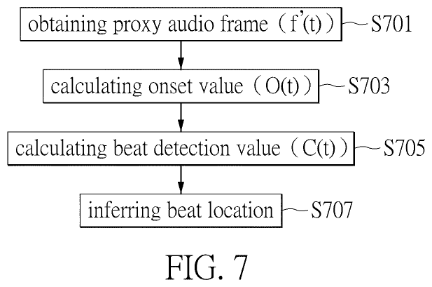

One of the objectives of the method for analyzing music rhythm in real time is to speculate the next beat location. Reference is made to FIG. 7, which is a flowchart illustrating a process of detecting the next beat location according to the speculated beat period according to one embodiment of the present disclosure.

In the beginning, such as in step S605 of FIG. 6, a proxy audio frame (f′(t)) is firstly obtained (step S701). As discussed in the above embodiments, in addition to speculating the new beat period, the auto-correlation function is referred to for calculating an onset value (O(t)) (step S703).

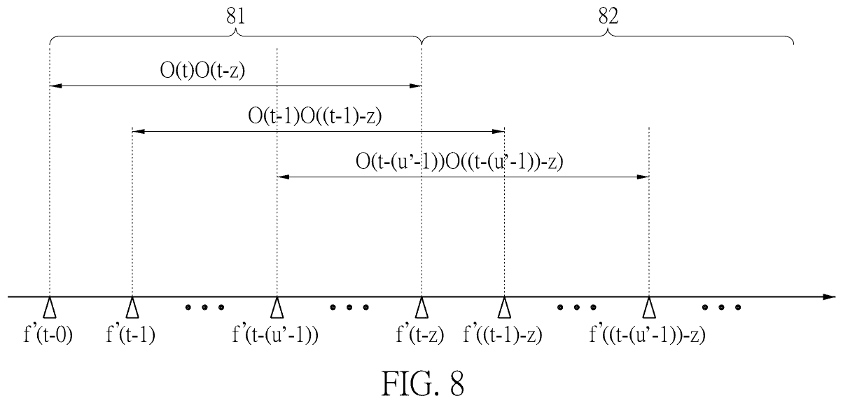

In the process of speculating the new beat period, reference is made to FIG. 8, which is a schematic diagram illustrating a process of using an auto-correlation function to speculate the beat period according to one embodiment of the present disclosure. In this process, the data of the audio frames in a past period of time (e.g., “u” seconds) is used to re-speculate a new beat period. According to one embodiment of the present disclosure, as shown in Equation 3, the new beat period (τ′) is re-speculated as a period “z” having the maximum of the auto-correlation function. The new beat period (τ′) can be represented by “τ′=arg Max ACF(z)”, in which “z=τ+20, . . . , τ−20.” That is, in order to reduce the amount of computation, the system is configured to search a certain quantity (e.g., 20) of the proxy audio frames (f′(t)). The system requires more computing power if the quantity of the proxy audio frames (f′(t)) is larger.

Taking past “u” seconds as an example, the data in the “u” seconds includes the quantity “u′” of the proxy audio frames (f′(t)) that can be represented by “u′=u*(sample rate/hop size).” The auto-correlation function (ACF) is exemplarily expressed by Equation 3. The auto-correlation function in Equation 3 introduces an onset value (O(t)) that refers to Equation 4.

$$\begin{matrix}ACF ( z ) = {\sum }_{k} O ( k ) O ( k - z ) ; k = t - 0 , … , t - ( {u}^{′} - 1 ) ; \\ if k - z < 0 , 0 ( k - z ) = 0.\end{matrix} \qquad Equation 3$$

$$O ( t ) = {\sum }_{k} {f}_{k}^{′} ( t ) {f}_{k}^{′} ( t ) ; k = 1 , … , frame size . \qquad Equation 4$$

The function “f′ₖ(t)” denotes a k-th sampling point of f(t). For example, if each f(t) includes 1024 sampling points, O(t) is a sum of values of all of the sampling points of f(t).

FIG. 8 shows the multiple proxy audio frames within a time period. The proxy audio frame (f′(t)) denotes a t-th proxy audio frame. Equation 4 shows that the onset value (O(t)) of each of the proxy audio frames (f′(t)) is calculated. FIG. 8 exemplarily shows that multiple proxy audio frames are included in past “u” seconds, and this period includes a first group data 81: f′(t−0), f′(t−1), . . . , f′(t−(u′−1)), and a second group data 82: f′(t−z), f′((t−1)−z), . . . , f((t−(u′−1))−z). The first group data 81 and the second group data 82 are separated by a period “z”.

For example, if the beat period τ=30, it means that one beat appears in every 30 proxy audio frames (f′(t)), and the number “z” is between “τ−20” and “τ+20”. If τ=30, τ−20, . . . , τ+20=10, 11, . . . , 50. The numeral “u” ′ is an amount of data in “u” seconds.

Thus, when the new beat period is speculated, the onset value (O(t)) of the proxy audio frame (f′(t)) is calculated. The onset value (O(t)) is a concept of an energy envelope. It is expected that every beat has a stronger or a strongest energy. Therefore, when speculating the beat period, a maximum of the onset value or a value that is calculated from the onset values is obtained. That is, the beat period can be speculated from the onset values of the proxy audio frames within a period of time. If the period “z” having the maximum of the auto-correlation function (ACF) is a correct beat period, the value (e.g., as O(t)O(t−z), O(t−1)O((t−1)−z), 0(t−(u′−1))O((t−(u′−1))−z)) multiplied by the onset values at the beats separated by “z” of the first group data 81 of FIG. 8 and the onset values at the beats separated by “z” of the second group data 82 of FIG. 8 will be a very large value. If the value “z” allows the value summing these multiplied onset values (e.g., O(t)O(t−z)+O(t−1)O((t−1)−z)+ . . . +O(t−(u′−1))O((t−(u′−1))−z)) to be a maximum, the value “z” is the latest beat period (r) to be speculated. Hence, the new beat period can be speculated through a specific operation (e.g., multiplication followed by addition) of the onset values in the auto-correlation function.

It should be noted that, in addition to the method using the auto-correlation function, the following methods can also be used (but are not limited thereto). For example, in a method of energy difference, a difference of an energy envelope between every two adjacent audio frames or proxy audio frames (f′(t)) can be calculated. The larger the difference of the energy envelope is, the greater the change of energy between two audio frames is. In this way, the onset value can be determined.

Furthermore, a spectral difference method can be incorporated to obtain an energy difference of a specific frequency band by performing the Fourier transform on the audio frames or the proxy audio frames. A larger energy difference means that there is a greater energy change in the frequency band, and an onset value can thus be determined. For example, the energy change can be determined according to a spectral distribution of drum beats acting as the rhythm in music, and the beat locations can be found according to the onset values.

Further, a phase deviation method can be incorporated to inspect the onset values in the audio based on phases of the audio. Still further, a complex spectral difference method can be used to detect the onset values that are used for tracing the beat locations of the music.

When a sum of the energy values of all of the sampling points in a specific proxy audio frame (f′(t)) is calculated, the onset values (O(t)) in the audio can be obtained. The larger the sum of the energy values is, the more characteristic the onset value is. Accordingly, the beat locations of the music can be determined. However, in order to more accurately determine the beat locations of the music, a beat detection value (C(t)) can be further calculated (step S705).

According to the above embodiments of the present disclosure, the auto-correlation function (ACF) uses the onset value of each of the audio frames as the characteristics for auto correlation, so as to obtain the beat period (T). Furthermore, the beat locations should be more precisely confirmed due to a normal person's sensitivity to rhythm. Therefore, in order to ensure that the beat periods can be correctly outputted, apart from speculating the beat period based on the onset values, the beat period for a past period of time is also referred to for determining whether or not to have the same characteristics for auto correlation. According to one embodiment of the present disclosure, the beat detection value (C(t)) is incorporated for acquiring the sampling points around the onset value (O(t)) through defined beat detection values.

The beat detection value (C(t)) is defined as Equation 5.

$$\begin{matrix}C ( t ) = ( 1 - α ) O ( t ) + α * Max ( C ( t + v ) * W ( v ) ) ; \\ wherein , v = - ( 2 τ ) , … , - ( \frac{τ}{2} ) ; \\ W ( v ) = exp ( \frac{- {( log ( \frac{- V}{τ} ) )}^{2}}{2} ) .\end{matrix} \qquad Equation 5$$

Here, “T” denotes the beat period, and the numerical value “u” denotes a weight value. In an embodiment of the present disclosure, the numerical value “u” is given by the system as a fixed initial value, and the numerical value “u” is used to determine a specific weight for weighting the calculation between the onset value and the beat detection value (C(t+v)) in the past period of time. For example, the earlier beat detection value is given a lower weight value, and the log-Gaussian transition weighting function “W” acts as a coefficient for the equation. The related citation is “Real-Time Beat-Synchronous Analysis of Musical Audio” published by A. M. Stark, M. E. P. Davies, and M. D. Plumbley in Proceedings of the 12th International Conference on Digital Audio Effects (DAFx-09) Como, Italy, Sep. 1-4, 2009. Furthermore, the variable “v” is used to define how long ago the beat detection value needs to be taken into consideration. In the present example, v=−(2τ), . . . , −(τ/2).

According to Equation 5, when 0<=t<=2τ, it may occur that the beat detection value C(t) lacks the beat detection value C(t+v), and the value “0” is then introduced. Taking the beat detection value C(0) as an example, since both beat detection values “C(−2τ)” and “C(−τ/2)” do not exist, the value “Max(C(t+v))” is actually “0”, and can be expressed by “C(0)=(1−α)O(t).” In this condition, only the onset value of the proxy audio frame (f′(0)) with “t=0” is referred to.

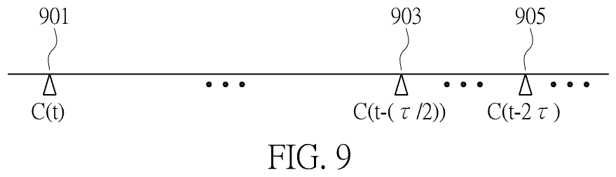

FIG. 9 is a schematic diagram illustrating a beat location being described by a beat detection value according to one embodiment of the present disclosure. In the schematic diagram, Equation 5 is used to calculate the beat detection value (C(t)) for a current beat 901, and both the beat detection values “C(t−(τ/2))” and “C(t−2τ)” indicative of two reference beats 903 and 905 that are expressed by “α*Max(C(t+v)*W(v))” of Equation 5.

As shown in Equation 5, the maximum (MAX) of the beat detection values in the multiple past beat periods (i) can be obtained. In the present example shown in the diagram, the maximum of the beat detection values of the two reference beats 903 and 905 is multiplied by the coefficient “W(v)”, and the product can be used as the beat detection value (C(t)) of the current beat 901 (step S705).

Through the above-described steps in accordance with Equation 5, the onset value (O(t)) for each of the proxy audio frames can be obtained, and the maximum beat detection value (Max(C(t+v)*W(v))) of the sampling points around the onset value can be calculated. The above two values can then be added with the weight value “α”, and can be used as the beat detection value of the proxy audio frame. Accordingly, the larger the beat detection value is, the more likely the audio frame is determined as a beat of the music.

Next, step S707 of FIG. 7 is proceeded to speculate the beat locations. According to one of the embodiments of the present disclosure, in order to minimize computation, instead of calculating all of the proxy audio frames (f′(t)), the next beat location can only be speculated when the current proxy audio frame (f′(t)) is determined to be at the location of half of the beat period (τ/2).

When speculating the next beat location, the beat detection values of all of the beats in the past period of time are used to speculate the beat detection values of the beats in the next beat period. Equation 6 is referred to for calculating the beat detection values C(t+x).

$$\begin{matrix}C ( t + x ) = Max ( C ( t + x + v ) * W ( v ) ) ; \\ wherein , x = 1 , … , τ ; v = - ( 2 τ ) , … , - ( τ / 2 ) ; \\ W ( v ) = exp ( \frac{- {( v - ( \frac{τ}{2} ) )}^{2}}{2 {( \frac{τ}{2} )}^{2}} ) .\end{matrix} \qquad Equation 6$$

Here, the beat detection value (C(t+x)) denotes the beat detection value of the proxy audio frame (f′(t+x)) at each time point “t+x” to be speculated within a next beat period (x=1, . . . ,τ) after the time point “t.” After that, the beat period (x′, t′) with the maximum beat detection value (C(t+x)) can be obtained, and can be used as the beat location for the next beat period. This means that the next beat is speculated to appear in a specific proxy audio frame (f′(t′)).

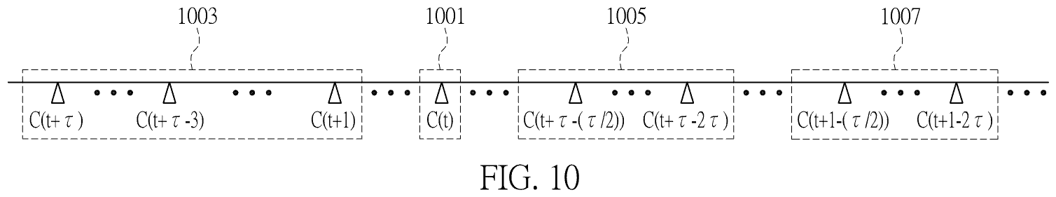

Reference is made to FIG. 10, which is a schematic diagram illustrating the next beat location being speculated through description of the beat detection value according to one embodiment of the present disclosure. According to Equation 6, the values “x=1”, “τ”, “v=−(2τ)”, and “v=−(τ/2)” are substituted into Equation 6 for forming the multiple beat detection values shown in FIG. 10. FIG. 10 schematically shows a beat detection value (C(t)) of a current beat 1001, beat detection values from “C(t+τ)” to “C(t+1)” of a next beat period 1003, beat detection values from “C(t+τ−(τ/2))” to “C(t+τ−2τ)” in a reference beat period 1005 that are used to acquire the maximum beat detection value in Equation 6, and beat detection values from “C(t+1−(τ/2))” to “C(t+1−2τ)” in another reference beat period 1007.

During computation, the maximum beat detection value (MAX) in the reference beat periods 1005 and 1007 is multiplied by the coefficient “W(v)”, and the product is used as the beat detection value of the next beat period 1003. In the present example shown in the diagram, the audio frame having the maximum beat detection value in the next beat period 1003 is speculated to be the location of the next beat. For example, in the diagram, if the maximum value of the beat detection values (C(t+τ−3), C(t+1), . . . , C,(t+τ)) in the next beat period 1003 is “C(t′)=C(t+τ−3)”, the corresponding proxy audio frame (f′(t+τ−3)) is speculated to be the audio frame having the next beat. At this time, the steps (e.g., step S213 of FIG. 2 or step S707 of FIG. 7) of speculating the next beat location are completed. Thus, the audio can be outputted when the speculated beat locations of the audio are added with the beat-prompting notes.

However, in the system for analyzing music rhythm in real time, the beat-prompting notes added in the music may disturb the person who listens to the music due to the change of the music rhythm at any time, and this problem still needs to be addressed. Therefore, a determination of beat stability is incorporated in the method for analyzing music rhythm in real time (step S215 of FIG. 2).

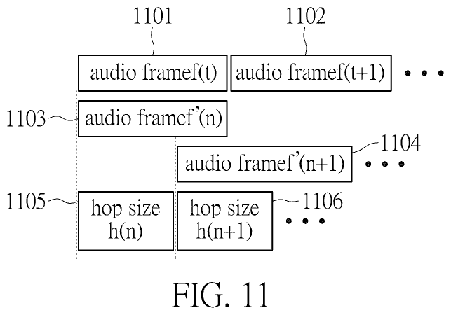

Firstly, the system should define what the beat stability is. Reference is made to FIG. 11, which is a schematic diagram illustrating frame information of an audio that is used to determine whether or not an audio rhythm is stable according to one embodiment of the present disclosure.

Based on the frame information shown in the diagram, if a current audio frame (f(t)) is determined as a beat, an auto-correlation function is used to re-speculate a new beat period according to an onset energy record for past “n” seconds. A mechanism of determining whether or not the rhythm is stable is introduced. If the audio rhythm is determined as stable, the current audio frame (f(t)) is regarded as a beat location, and is referred to as a beat frame (i.e., where the beat-prompting note is added). Equation 7 is used to determine whether or not the beat is stable.

In the diagram, an audio frame (f(t)) 1101 and another audio frame (f(t+1)) 1102 that are at two consecutive time points are shown. After a hop size (h(n)) 1105 and a hop size (h(n+1)) 1106 are calculated, a proxy audio frame (f′(n)) 1103 and a proxy audio frame (f′(n+1)) 1104 can be obtained. If the audio frames (f(t0′), f′(t1′), f(t2′), . . . , f(tn′)) are speculated as the beat frames, after a next beat location in the new beat period is obtained, whether or not the rhythm of the audio is stable can be determined by retracing multiple beat locations and calculating multiple time differences (“d”) between every two adjacent beat locations.

If the “d” values (dₙ₋₀, dₙ₋₁, . . . , dₙ₋ᵢ, i.e., the time differences shown in Equation 7) to be calculated by retracing “i” times are the same, it means that the beat periods are the same, and the audio is determined to have a stable rhythm. Afterwards, the beat-prompting notes are configured to be added at the beat locations.

$$\begin{matrix}{d}_{n - 0} = {t}_{n - 0 ’} - {t}_{n - 1 ’} \\ {d}_{n - 1} = {t}_{n - 1 ’} - {t}_{n - 2 ’} \\ … \\ {d}_{n - i} = {t}_{n - i - 1 ’} - {t}_{n - i ’}\end{matrix} \qquad Equation 7$$

When the method for analyzing music rhythm in real time of the present disclosure is applied to a specific device, the function of beat-prompting notes can be activated if the received data is determined to be an audio having a stable rhythm. The beat-prompting notes can be added to the audio in a normal, an allegro, or an adagio speed. For example, in Equation 7, the beat-prompting notes can be selectively added to the audio frames that are determined as the beat locations. The beat-prompting notes can be added to the audio frames (f(tₙ′), f(tₙ′+d)) at a speed of one time BPM (beats per minute) in a normal mode; the beat-prompting notes can be added to the audio frames (f(tₙ′), f(tₙ′+d/2)) at a speed of double BPM in an allegro mode; or the beat-prompting notes can be added to the audio frames (f(tₙ′), f(tₙ′+2d)) at a speed of half BPM in an adagio mode.

Further, the system introduces an intelligent model that has learned various rhythms, and the system having this intelligent model can accurately speculate the beat period. Accordingly, the system can achieve real-time music rhythm analysis for accurately adding the beat-prompting notes.

In conclusion, in the method and the system for analyzing music rhythm in real time provided by the present disclosure, the beat period is firstly determined by analyzing the frame information of the audio, so as to determine the beat locations. In this way, the beat-prompting notes can be added when the music has a stable rhythm. The rhythm in the music can be analyzed in real time, and the purpose of adding the beat-prompting noted into the audio on demand can be achieved.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A method for analyzing music rhythm in real time, which is operated in a system, the method comprising:
receiving and decoding an audio to acquire frame information of the audio, wherein the frame information includes a sampling rate;
obtaining a hop size according to a frame size and an overlapped frame size, and calculating a frame rate according to the sampling rate and the hop size;
calculating an initial value of a beat period according to the sampling rate and an initial BPM (beats per minute) value, so as to obtain a beat location based on a quantity of sampling points in a beat; and
speculating a next beat location by a recursive algorithm, wherein the frame rate is referred to for calculating a quantity of audio frames in a past period of time, and a new beat period is calculated according to beats per minute, so as to speculate the next beat location according to the new beat period;
wherein the system is configured to re-calculate the new beat period according to the quantity of the audio frames in the past period of time at intervals, so as to re-speculate the next beat location.

2. The method according to claim 1, wherein, after the next beat location of the new beat period is obtained, multiple time differences of multiple adjacent beat locations are calculated by retracing multiple beat locations, and the system determines whether or not the audio has a stable rhythm.

3. The method according to claim 1, wherein, when the audio is a multi-channel audio, an averaging operation is performed on digital signals of multiple audio frames at a same time for forming a mono-channel audio that is provided for real-time music rhythm analysis.

4. The method according to claim 3, wherein each of the audio frames in each channel of the multi-channel audio is the digital signals in a form of pulse-code modulation.

5. The method according to claim 1, wherein the frame rate indicates a quantity of proxy audio frames in one second, and the proxy audio frame is obtained based on the frame size of an original audio frame and the overlapped frame size set by the system.

6. The method according to claim 5, wherein, in the process of calculating the new beat period, an auto-correlation function is adopted to find out a repeating pattern according to a correlation of the frame information of the audio at different time points, and the new beat period is re-calculated based on a period having a maximum of the auto-correlation function.

7. The method according to claim 6, wherein the auto-correlation function introduces an onset value, and the onset value of each one of the proxy audio frames in a time period is calculated; wherein a maximum of the onset values or values calculated from the onset values in the time period is determined for speculating the new beat period.

8. The method according to claim 7, wherein a beat detection value is introduced for calculating a maximum beat characteristic value of the sampling points around the onset values of the proxy audio frames in the time period, and the maximum beat characteristic value acts as the beat detection value of the proxy audio frame; wherein the beat detection values of all of the beats in a past beat period are further referred to for speculating beat detection values in a next beat period, and a maximum of the beat detection values in the next beat period is regarded as a beat location of the next beat period.

9. The method according to claim 1, wherein, after the next beat location of the new beat period is obtained, multiple time differences of multiple adjacent beat locations are calculated by retracing multiple beat locations, and the system determines whether or not the audio has a stable rhythm.

10. The method according to claim 9, wherein, when the system determines that the audio has the stable rhythm, a beat-prompting note is added at each beat location.

11. A system for analyzing music rhythm in real time, which is installed in a device, the system comprising:
an audio analysis module, wherein the audio analysis module is connected with an audio-processing circuit of the device for performing a method for analyzing music rhythm in real time, and the method includes:
receiving an audio via an input interface, and decoding the audio by the audio-processing circuit to acquire frame information of the audio, wherein the frame information includes a sampling rate;
obtaining a hop size according to a frame size and an overlapped frame size and calculating a frame rate according to the sampling rate and the hop size;
calculating an initial value of a beat period according to the sampling rate and an initial BPM (beats per minute) value so as to obtain a beat location based on a quantity of sampling points in a beat; and
speculating a next beat location by a recursive algorithm, wherein the frame rate is referred to for calculating a quantity of audio frames in a past period of time, and a new beat period is calculated according to beats per minute, so as to speculate the next beat location according to the new beat period;
wherein the system is configured to re-calculate the new beat period according to the quantity of the audio frames in the past period of time at intervals, so as to re-speculate the next beat location.

12. The system according to claim 11, wherein, after the next beat location of the new beat period is obtained, multiple time differences of multiple adjacent beat locations are calculated by retracing multiple beat locations, and the system determines whether or not the audio has a stable rhythm.

13. The system according to claim 11, wherein, when the audio is a pulse-code-modulation multi-channel audio, an averaging operation is performed on digital signals of multiple audio frames at a same time for forming a mono-channel audio that is provided for real-time music rhythm analysis.

14. The system according to claim 13, wherein the frame rate indicates a quantity of proxy audio frames in one second, and the proxy audio frame is obtained based on the frame size of an original audio frame and the overlapped frame size set by the system.

15. The system according to claim 14, wherein, in the process of calculating the new beat period, an auto-correlation function is adopted to find out a repeating pattern according to a correlation of the frame information of the audio at different time points, and the new beat period is re-calculated based on a period having a maximum of the auto-correlation function.

16. The system according to claim 15, wherein the auto-correlation function introduces an onset value and the onset value of each one of the proxy audio frames in a time period is calculated; wherein a maximum of the onset values or values calculated from the onset values in the time period is determined for speculating the new beat period.

17. The system according to claim 16, wherein the system introduces a beat detection value for calculating a maximum beat characteristic value of the sampling points around the onset values of the proxy audio frames in the time period, and the maximum beat characteristic value acts as the beat detection value of the proxy audio frame; wherein the beat detection values of all of the beats in a past beat period are further referred to for speculating beat detection values in a next beat period, and a maximum of the beat detection values in the next beat period is regarded as a beat location of the next beat period.

18. The system according to claim 17, wherein, after the next beat location of the new beat period is obtained, multiple time differences of multiple adjacent beat locations are calculated by retracing multiple beat locations, and the system determines whether or not the audio has a stable rhythm.

19. The system according to claim 18, wherein, when the system determines that the audio has the stable rhythm, a beat-prompting note is added at each beat location.

20. The system according to claim 19, wherein, when the audio-processing circuit outputs the processed audio via an output interface, the audio is synthesized with the beat-prompting note that is added at each beat location.
